(19) United States
(12) Patent Application Publication
(10) Pub. No.: US 2009/0273734 A1
(43) Pub. Date: Nov. 5, 2009

(54) Structure of light emitting device array

(76) Inventors: Feng Li, Oxnard, CA (US); Gang Xu, Cupertino, CA (US); Bingwen Liang, Sunnyvale, CA (US); Chen-Jean Chou, New City, NY (US)

Correspondence Address: CHEN-JEAN CHOU, 21 RIDGEFIELD ROAD, NEW CITY, NY, 10956, US

(21) Appl. No.: 12/435,400

(22) Filed: May 4, 2009

Related U.S. Application Data
(60) Provisional application No. 61/050,235, filed on May 4, 2008.

(51) Int. Cl. G02F 1/13357

(52) U.S. Cl. 349/65

(57) ABSTRACT

A LCD backlight with mosaic structure is provided. Each of the backlight unit blocks comprises light sources, light guide plate, electric controlling circuitry and mechanical interfacing features.

### CROSS REFERENCE TO RELATED APPLICATIONS

The present application claims priority of U.S. Provisional Patent Application No. 61/050,235, filed on May 4, 2008.

### BACKGROUND OF THE INVENTION

1. Field of the Invention

The present invention relates to the structure for an LCD backlight illuminated by an LED array, or an array of other point light sources. More specifically, the present invention provides a structure of basic lighting mosaic units with which a larger LCD backlight can be construction with good lighting efficiency and uniformity, as well as low cost and construction cycle time.

2. Description of the Prior Art

Currently there are two types of LED Backlight for LCD panels. In one type of the LCD such as laptop or mobile phones, the light from the LED sources 108 are first directed into the edge of a light guide plate (LGP) 101 as shown in FIG. 1 . The LGP 101 distributes the light to all area of the LCD panel to achieve a uniform illumination. For larger size LCD panels, such as that used for monitor or TV as shown in FIG. 2, the LED light sources 205 are arranged in a 2D array on a substrate behind the LCD panel 202 and diffuser 203. To achieve uniform illumination in front of the LCD panel, a minimum spacing is needed to mix the light from neighboring LED sources. Such minimum spacing sets a limit to the reduction of the display thickness.

Furthermore, as the LCD size grows larger for TV applications, the size of the LED array substrate also grows, making it very complicated and bulky. It is difficult and costly to solve the problems of its mechanical support thermal cooling and electrical connecting and control.

The present invention provides a structure and method to reduce the spacing between the backlight and LCD panel, to simplify the mechanical and optical designs and to reduce the manufacturing cost and cycle time.

### SUMMARY OF THE INVENTION

The present invention describes a lighting element as backlighting unit block (BLUB) from which the whole backlight unit (BLU) can be constructed like a 2D mosaic. Each of the BLUB integrates a number of LED as light sources, a light guide to distribute the light uniformly over the BLUB and to eject the light towards the LCD panel, the same way as LGP of a side-illuminating backlight for a laptop, an electric circuitry to control the LED light sources as a unit block, and a number of mechanical structures so that the BLUB can be interfaced and secured to a supporting structure behind the 2D BLUB array. To make the BLUB array looks seamless, as observed by the viewer in the front of LCD panel, a specially designed diffusing film is applied onto the front surface of the BLUB array. Behind the BLUB array, a mechanical supporting structure is specially designed to secure the BLU structurally to the display module backing.

### BRIEF DESCRIPTION OF THE DRAWING

FIG. 1 is a schematic of a prior art, for an edgelit BLU.

FIG. 2 is a schematic of a prior art, for direct backlight.

FIG. 3 is a schematic illustration of the present invention.

FIG. 4 is a schematic of a preferred embodiment of the present invention.

FIG. 5 is a schematic illustration of light distribution structure of the present invention.

FIG. 6 is a schematic illustration of light distribution structure of the present invention.

FIGS. 7a and 7b are schematic illustrations of light exit cones from the light source.

FIG. 8 is a schematic illustration of spacers at the edges of neighboring BLUBs.

FIG. 9 is a schematic illustration of mechanical structures at the edges of neighboring BLUBs.

FIGS. 10A and 10B are a top view and a cross section view of a preferred embodiment for the present invention.

FIG. 11 is a preferred embodiment of the present invention with light sources at two corners of the light guide.

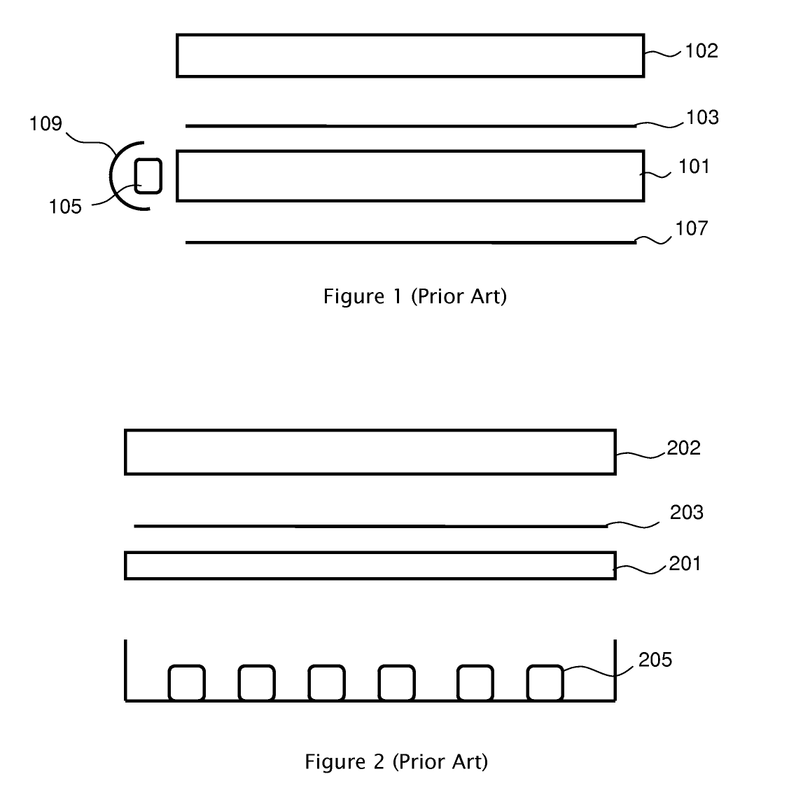

### DETAILED DESCRIPTION OF THE INVENTION

A mosaic lighting structure for LCD backlight is provided in this invention. The entire backlight is constructed with an assembly of a plurality of lighting elements, the backlight unit blocks (BLUB). Each of the backlight unit blocks comprises light sources, light guide plate, and may also comprises electrical control circuitry and mechanical interfacing features.

The present invention is herein described in detail with reference to the drawings.

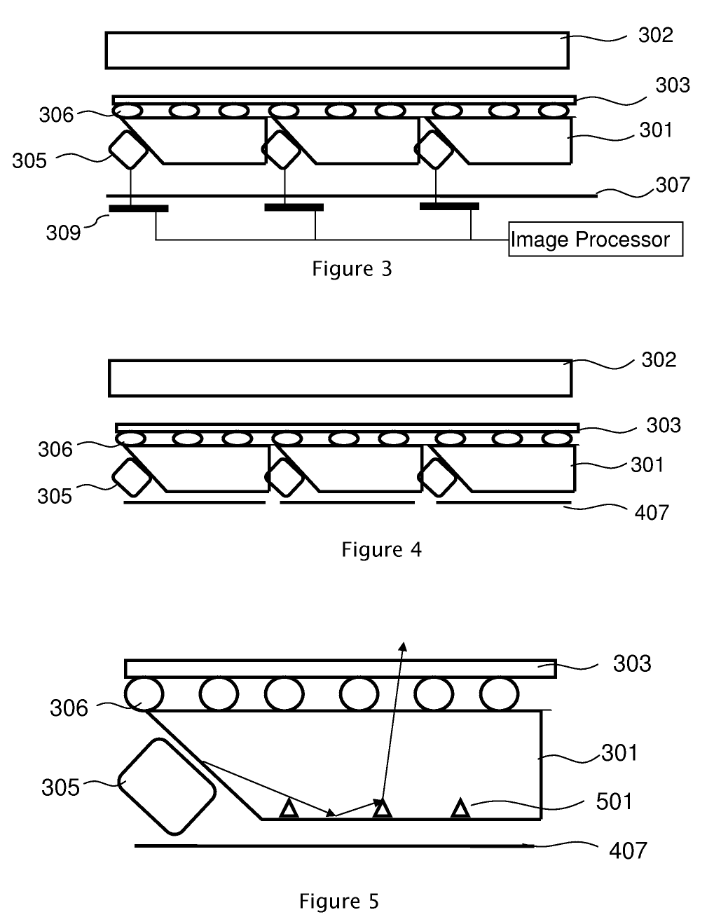

FIG. 3 provides a preferred embodiment of the present invention, wherein 305 is a light source, 301 is a light guide, and 309 is a control circuit. The assembly of 301 and 305 forms a BLUB. In a preferred embodiment, a BLUB may also include a control circuit 309 integrated as part of the BLUB. A number of these BLUBs are placed together to form the entire backlight unit (BLU). Layer 303 is a light diffusing film, which is applied onto the BLUB array by a layer of light coupling elements, labeled as 306 in FIG. 3. The size and shape of these light coupling elements are chosen so that the gap between adjacent BLUBs is blurred and invisible as viewed from the front surface of the LCD panel 302. In a preferred embodiment of the invention, the back reflector 307 may be placed as a single piece behind the BLUB array, as shown in FIG. 3. In another embodiment, the reflector can be separate pieces; each of the reflectors 407 is integrated into each of the BLUB, as shown in FIG. 4.

In a preferred embodiment for the present invention, as shown in FIG. 3, an electric circuit board 309 is attached behind the reflector 307 to provide electric power to the light source. The circuit board may also include a control circuitry so that the BLUB can be controlled by a defined interface. The control board receives control signals from an image processor and sets the intensity of the lighting element according to the received signals.

FIG. 5 provides further detail of a preferred embodiment of the present invention. A lighting element (BLUB) comprises at least one light source 305. The light guide plate 301 comprises multiple light extracting features 501 on its back side. The light from the light source 305 enters the light guide plate at one facet of the light guide 301. This entering facet is made with an angle off the normal axis of the light guide slab 301. After entering the light guide, the light travels across the light guide 301 and is redirected by the light extracting feature 501 toward the front surface and the LCD display. The light then exits the front surface and illuminates the LCD display. The light guide plate can be made by injection molding, or UV and thermal embossing. The light extracting elements can be made onto the light guide during its manufacturing process, or after by chemical etching or mechanical stamping.

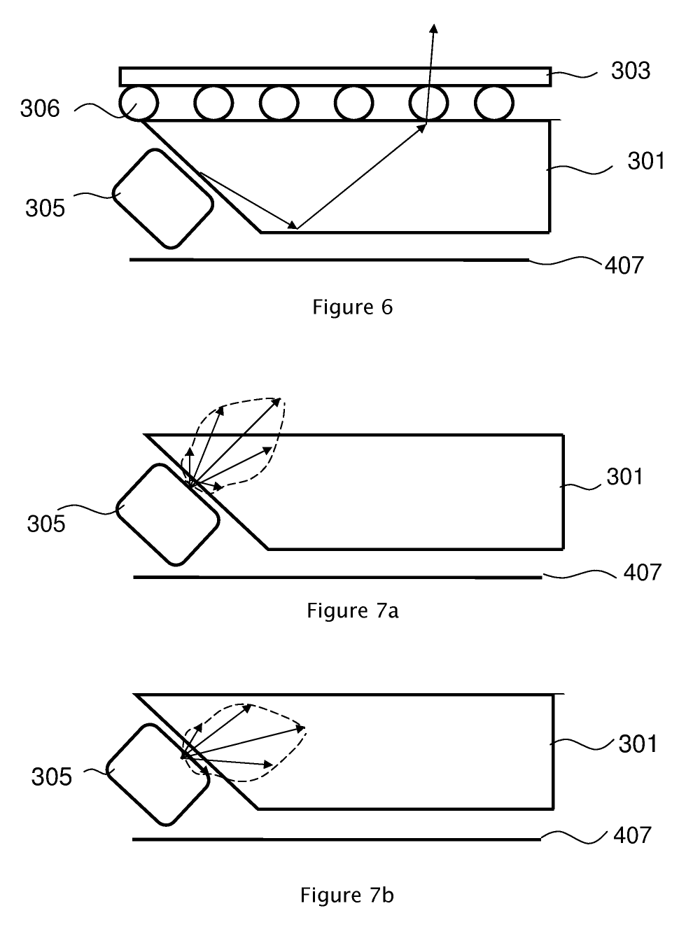

FIG. 6 discloses another preferred embodiment of the present invention. There is no light extracting features on the back of the light guide plate. The light traveling inside the light guide plate is extracted by the light coupling elements in its front surface. The light coupling elements 306 can be manufactured onto the surface of the light guide plate, as described in previous paragraph, or by depositing a plurality of dots that couple the light from the light guide plate into the diffusing film 3. The light coupling elements may also comprise light diffusing elements to enhance its diffusing capability. The deposition method for light coupling elements includes, but is not limited to, printing onto the surface of the light guide plate 301, or printing onto the light diffusing film 303. Other methods of manufacturing may also be used.

In a preferred embodiment of the present invention, the light exiting surface of the light source is orientated obliquely to the front surface of the light guide plate 301, as shown in FIG. 6, to hide the light source from being visible by the viewer in front of the LCD panel. For most of the light sources, the light intensity decreases symmetrically as being viewed from the normal of its exiting surface, as shown in FIG. 7a. In a preferred embodiment of the present invention, the axis of illumination can be modified so that it is tilted from the normal of the exiting surface, as shown in FIG. 7b.

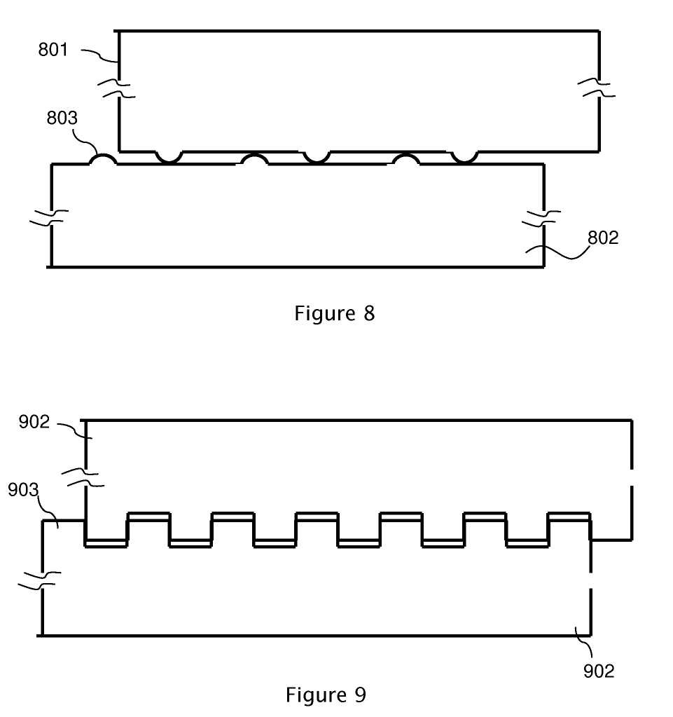

In another preferred embodiments of the present invention, an air gap is needed between neighboring BLUBs. To help maintaining the gap, spacers can be used in the gap. In FIG. 8 the spacers 803 can be injection molded at the edges of neighboring light guide plates 801 and 802. The size of the spacers can be as small as micrometers, to make the gap small.

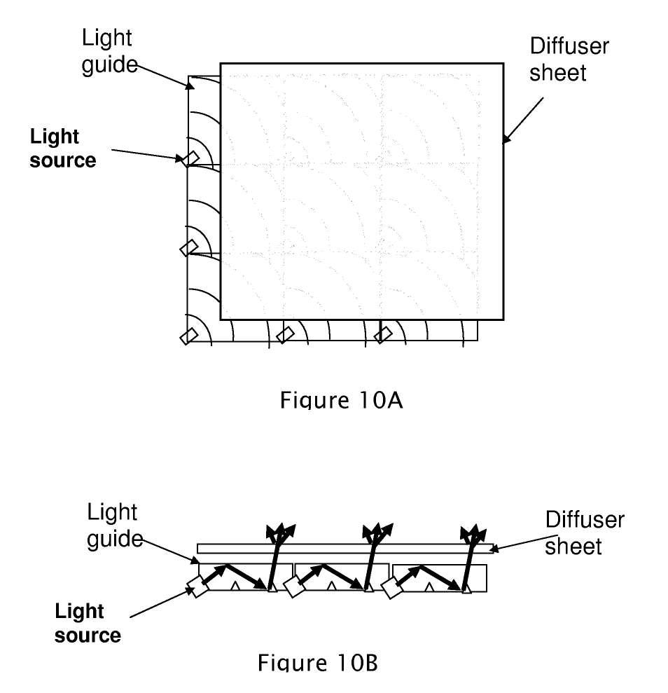

In a preferred embodiment for the present invention, mechanical structure 903 can be designed and fabricated at the edge of the BLUBs 801 and 802, as shown in FIG. 9, to prevent the BLUBs from slipping over one another and to enhance the mechanical integrity of BLUBs.

In a preferred embodiment for the present invention, as shown in FIG. 3, an electric circuit board is attached behind the reflector 407 to provide electric power to the light source. The circuit board may also include a control circuitry so that the BLUB can be controlled by a defined interface.

FIG. 10 illustrates a top view and cross section view of a preferred embodiment for the present invention, wherein the light source is placed at the corner of each of the BLUBs, and the light extracting features, located on the back of the light guide plate, are shaped curvilinearly around the injection point of the light source. An air gap, not shown in the drawing, is kept between the neighboring BLUBs so that light within each of the BLUBs is isolated from each other. The extracted light is diffused by a diffuser film and then directed towards the LCD panel. The light coupling elements between the light guide plate and the diffuser film help to hide the seams between neighboring BLUBs and may also give additional diffusing capability and light extracting capability.

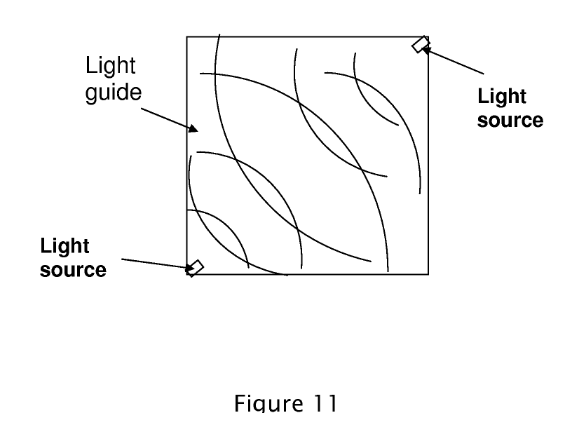

In other preferred embodiments number and locations of light sources in each BLUB, the shape and distribution of light extracting elements may be varied to achieve uniform illumination. In one preferred embodiment, one BLUB comprises two LED light sources located at the opposite corners. Each of the corners where the light source is located is cut to an angled facet for light entering. In another preferred embodiment, LED light sources and angled facets are constructed at four corners of the BLUB. FIG. 11 shows a BLUB with light sources at two opposite corners of the light guide.

Various structures may be used to achieve the function of mosaic backlight unit. Specific embodiments of its construction were provided in this description to illustrate the operation principles of this invention. The application of the principles of the present invention however is not limited by such examples. It is conceivable that various types of materials and structures may be used to construct such mosaic structure, and all such variations are embraced by the present invention.

Although various embodiments utilizing the principles of the present invention have been shown and described in detail herein, those skilled in the art can readily devise many other variances, modifications, and extensions that still incorporate the principles disclosed in the present invention. The scope of the present invention embraces all such variances, and shall not be construed as limited by the number of elements, number of layers, or specific direction and angles.

A LCD backlight with mosaic structure is provided. Each of the backlight unit blocks comprises light sources, light guide plate, electric controlling circuitry and mechanical interfacing features.

What is claimed is:

1. A display apparatus comprising a plurality of lighting elements illuminating an image display panel comprising a plurality of transmissive light valves; wherein each said lighting element comprises at least a light emitting device, a light guide directing the light first in a direction parallel to the plan of said image display panel, and then redirecting the light toward said display panel; wherein each said lighting element illuminates a fraction of the total display area.

2. The display according to claim 1 wherein each said lighting element further comprises a control circuit regulating the intensity of the light output of said lighting element according to a control signal.

3. The display apparatus according to claim 2 wherein said control circuit regulating the intensity of the light output according to a control signal by adjusting the current directed to the light emitting device.

4. The display apparatus according to claim 3 wherein said control signal is proportional to the brightness of the image displayed in the area of the corresponding element.

5. The display apparatus according to claim 1 wherein said plurality of lighting elements collectively deliver an uniform illumination to the entire display panel when each and every lighting element is set to a calibrated light intensity.

6. The display according to claim 1 wherein said light guide comprises multiple light extracting features on its back side to direct light toward the front face of said light guide.

7. The display according to 1 wherein said light guide comprises light coupling structure on its front surface; said light coupling structure extract light to direct the light to exit the front face of said light guide.

8. The display according to claim 1 wherein said light guide is arranged to maintain an air gap with the adjacent light guide.

9. The display according to claim 8 wherein said light guide comprises spacer structure on its edge; said spacer structure maintaining a minimum spacing between two adjacent light guides, thereby maintains an air gap between the adjacent light guides.

10. The display according to claim 1 wherein at least a lighting element comprises a reflector at its back side to reflect light toward the front side.

11. The display according to claim 1 wherein said lighting element comprises at least a light emitting device located at a corner of said light guide.

12. The display according to claim 1 wherein said light guide comprises light extracting structure on the front surface where the light exits the light guide; wherein the light extracting structure comprises groves or waving patterns on the surface of the light guide.
